(19) United States
(12) Patent Application Publication
(10) Pub. No.: US 2008/0063016 A1
(43) Pub. Date: Mar. 13, 2008

(54) Thermal compensation in semiconductor lasers

(76) Inventors: Vikram Bhatia, Painted Post, NY (US); Martin Hai Hu, Painted Post, NY (US); Xingsheng Liu, Santa Clara, CA (US); David August Sniezek Loeber, Horseheads, NY (US); Daniel Ohen Ricketts, Corning, NY (US); Chung-En Zah, Holmdel, NJ (US)

Correspondence Address: CORNING INCORPORATED, SP-TI-3-1, CORNING, NY, 14831, US

(21) Appl. No.: 11/520,223

(22) Filed: Sep. 13, 2006

(51) Int. Cl. H01S 3/04

(52) U.S. Cl. 372/34

(57) ABSTRACT

The present invention relates to methods for modulating a semiconductor laser and wavelength matching to a wavelength converter using monolithic micro-heaters integrated in the semiconductor laser. The present invention also relates to wavelength matching and stabilization in laser sources in general, without regard to whether the laser is modulated or whether second harmonic generation is utilized in the laser source. According to one embodiment of the present invention, a method of compensating for thermally induced patterning effects in a semiconductor laser is provided where the laser's heating element driving current I_{H} is set to a relatively high magnitude when the laser's driving current I_{D} is at a relatively low magnitude. Additional embodiments are disclosed and claimed.

### BACKGROUND OF THE INVENTION

The present invention relates generally to semiconductor lasers and, more particularly to the use of micro-heaters to compensate for mode hops and wavelength drift in semiconductor lasers.

### SUMMARY OF THE INVENTION

The present invention relates generally to semiconductor lasers, which may be configured in a variety of ways. For example and by way of illustration, not limitation, short wavelength sources can be configured for high-speed modulation by combining a single-wavelength semiconductor laser, such as a distributed feedback (DFB) laser or a distributed Bragg reflector (DBR) laser, with a light wavelength conversion device, such as a second harmonic generation (SHG) crystal. The SHG crystal can be configured to generate higher harmonic waves of the fundamental laser signal by tuning, for example, a 1060 nm DBR or DFB laser to the spectral center of a SHG crystal, which converts the wavelength to 530 nm. However, the wavelength conversion efficiency of a SHG crystal, such as an MgO-doped periodically poled lithium niobate (PPLN), is strongly dependent on the wavelength matching between the laser diode and the SHG device. As will be appreciated by those familiar with laser design DFB lasers are resonant-cavity lasers using grids or similar structures etched into the semiconductor material as a reflective medium. DBR lasers are lasers in which the etched grating is physically separated from the electronic pumping area of the semiconductor laser. SHG crystals use second harmonic generation properties of non-linear crystals to frequency double laser radiation.

The allowable wavelength width of a PPLN SHG device is very small—for a typical PPLN SHG device, the full width half maximum (FWHM) wavelength conversion bandwidth is only 0.16 nm, which translates to a temperature change of about 2.7° C. Once the input wavelength deviates from the characteristic phase-matching wavelength of the SHG, the output power at the target wavelength drops drastically. The present inventors have recognized that a number of operating parameters adversely affect wavelength matching in these types of laser devices. For example, the wavelength of a DBR laser changes when the driving current on the gain section is varied. Further, operating temperature changes have differing affects on the phase-matching wavelength of the SHG and the laser wavelength. Accordingly, it is difficult to fabricate a package where the laser diode and the SHG crystal are perfectly wavelength matched.

Given the challenges associated with wavelength matching and stabilization in developing laser sources using second harmonic generation, the present inventors have recognized potential benefits for semiconductor lasers that can be actively tuned in order to achieve optimum output power through proper wavelength matching with SHG crystals and other wavelength conversion devices. For example, the present inventors have recognized that short wavelength devices can be modulated at high speeds without excessive noise while maintaining a non-fluctuating second harmonic output power if the wavelength of the semiconductor is maintained at a stable value during operation. For video applications, the optical power (green light, for example) often needs to be modulated at a fundamental frequency of 10 to 100 MHz and at extinction ratio of ˜40 dB. This combination of high modulation speed and large on/off ratio remain a challenging task to overcome. The present invention relates to methods for modulating a semiconductor laser and wavelength matching to a wavelength converter using monolithic micro-heaters integrated in the semiconductor laser. The present invention also relates to wavelength matching and stabilization in laser sources in general, without regard to whether the laser is modulated or whether second harmonic generation is utilized in the laser source.

It is to be understood that the following detailed description present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1A is a schematic illustration of a DFB or similar type semiconductor laser optically coupled to a light wavelength conversion device and including micro-heating element structure according to the present invention;

FIG. 1B is a schematic illustration of a DBR or similar type semiconductor laser optically coupled to a light wavelength conversion device and including micro-heating element structure according to the present invention;

FIG. 2A illustrates temperature increase in a DBR semiconductor laser without the benefit of thermal compensation according to the present invention;

FIG. 2B illustrates changes in lasing wavelength over time as the gain section of a DBR semiconductor laser is driven in a conventional manner;

FIG. 3A illustrates temperature increase in a DFB semiconductor laser without the benefit of thermal compensation according to the present invention;

FIG. 3B illustrates the manner in which a thermally induced patterning effect causes laser wavelength drift over time in a conventionally-driven DFB semiconductor laser;

FIG. 4 is a cross-sectional schematic illustration of a semiconductor laser incorporating a micro-heating element structure according to one embodiment of the present invention;

FIG. 5 is a plan view, schematic illustration of an electrode layer including a driving electrode structure and a micro-heating element structure according to the present invention;

FIG. 6 is a schematic illustration of a semiconductor laser incorporating a micro-heating element structure according to another embodiment of the present invention;

FIGS. 7 and 8 are timing diagrams illustrating a method of compensating for thermally induced patterning effects in a semiconductor laser according to one embodiment of the present invention;

FIG. 9 illustrates junction temperature overshoot as heating element driving current I_{H} is decreased and laser driving current I_{D} is increased in a semiconductor laser; and

FIGS. 10 and 11 are timing diagrams illustrating methods of compensating for thermally induced patterning effects in a semiconductor laser according to additional embodiments of the present invention.

### DETAILED DESCRIPTION

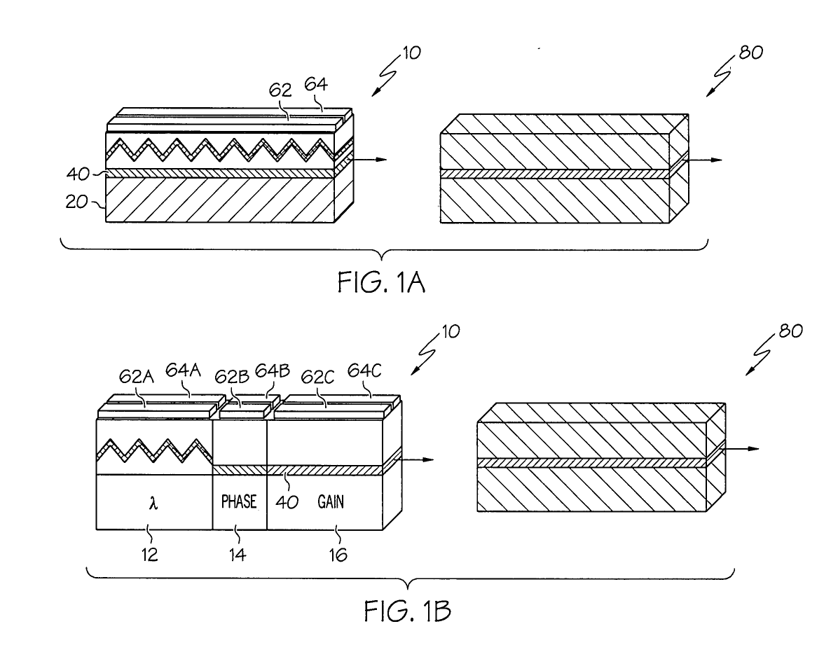

FIGS. 1A and 1B, are respective schematic illustrations of DFB and DBR semiconductor lasers 10 optically coupled to light wavelength conversion devices 80. The light beam emitted by the semiconductor laser 10 can be either directly coupled into the waveguide of the wavelength conversion device 80 or can be coupled through collimating and focusing optics or some type of suitable optical element or optical system. The wavelength conversion device 80 converts the incident light into higher harmonic waves and outputs the converted signal.

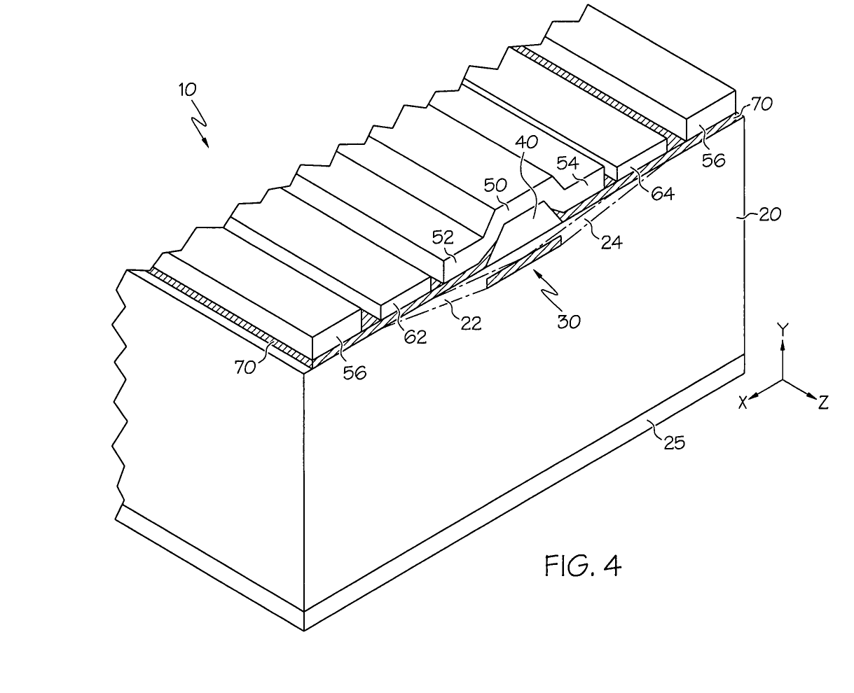

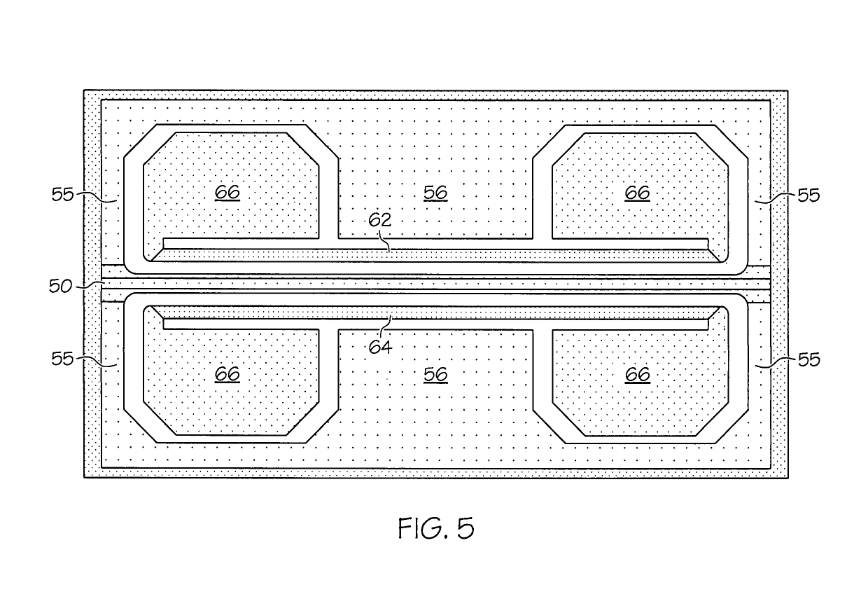

As will be appreciated by those familiar with DFB laser design, the DFB semiconductor laser 10 illustrated schematically in FIG. 1A comprises a distributed feedback grating that extends generally along the direction of a ridge waveguide 40 incorporated within the laser 10. Driving electrodes, not shown in FIG. 1A but discussed below with reference to FIGS. 4-6, are incorporated in the laser device to generate the electrical bias V_{BIAS} necessary for operation of the laser 10. Heating element strips 62, 64, also described in further detail below, extend along at least a portion of the distributed feedback grating, on opposite sides of the ridge waveguide of the laser 10. For clarity of illustration, the relative size of the heating element strips 62 and 64 has been exaggerated and the ridge waveguide 40 has been illustrated schematically without regard to its actual position within the laser 10. FIGS. 4-5 and the accompanying text provide a better description of one preferred configuration of the waveguide 40, driving electrodes, and heating element strips 62, 64 for use in the context of the present invention.

As will be appreciated by those familiar with DBR laser design, the DBR laser 10 illustrated schematically in FIG. 1B comprises a wavelength selective region 12, a phase matching region 14, and a gain region 16. For example, the wavelength selective region 12 typically comprises a first order or second order Bragg grating that is positioned outside the active region of the laser cavity. This section provides wavelength selection, as the grating acts as a mirror whose reflection coefficient depends on the wavelength. The gain region 16 of the DBR laser 10 provides the major optical gain of the laser and the phase matching region 14 creates an adjustable phase shift between the gain material of the gain region 16 and the reflective material of the wavelength selective region 12. The wavelength selective region 12 may be provided in a number of suitable alternative configurations that may or may not employ a Bragg grating. The ridge waveguide 40 extends through the wavelength selective region 12, the phase matching region 14, and the gain region 16. Heating element strips 62A, 64A, 62B, 64B, 62C, and 64C are incorporated in the wavelength selective region 12, the phase matching region 14, the gain region 16, or combinations thereof, and generally along the direction of a ridge waveguide 40.

The wavelength conversion efficiency of the wavelength conversion device 80 illustrated in FIGS. 1A and 1B is dependent on the wavelength matching between the semiconductor laser 10 and the wavelength conversion device 80. The output power of the higher harmonic light wave generated in the wavelength conversion device 80 drops drastically when the output wavelength of the laser 10 deviates from the wavelength conversion bandwidth of the wavelength conversion device 80. For example, in the case of a 12 mm-long PPLN SHG device, a temperature change in the semiconductor laser 10 of about 2° C. will typically be enough to take the output wavelength of the laser 10 outside of the 0.16 nm full width half maximum (FWHM) wavelength conversion bandwidth of the wavelength conversion device 80.

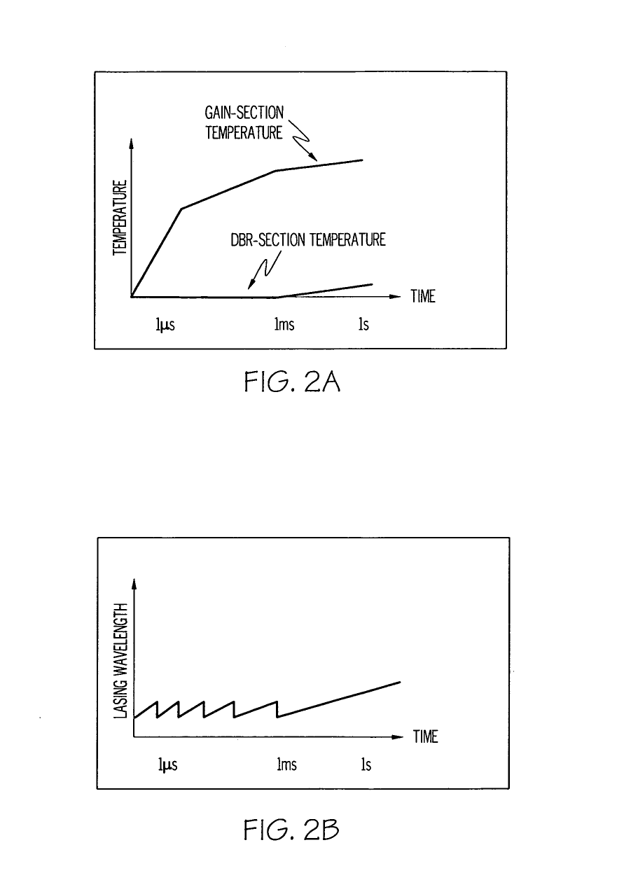

The present inventors have recognized that current injection into a semiconductor laser changes the temperature of the laser. For example, referring to FIGS. 2A and 2B, as the gain section of a DBR semiconductor laser is driven in a conventional manner, the active region and cladding region of the gain section are initially heated and the refractive index of the gain section increases. This results in an increase in the optical path length and, as is illustrated in FIG. 2B, the lasing optical spectrum moves towards a longer wavelength over time. This mode-hopping phenomenon repeats in the manner illustrated in FIG. 2B until the heat generated from the driving current propagates through the gain-section thickness and reaches the bottom of the semiconductor laser. At this point, e.g., at about 1 ms in the embodiment illustrated in FIGS. 2A and 2B, the whole laser chip including the gain, phase and DBR sections begins to see a significant temperature rise and the lasing wavelength increases steadily with increasing temperature over time. This steady increase in temperature is illustrated graphically in FIG. 2B, starting at about 1 ms.

This thermally-induced wavelength change leads to an undesirable patterning effect for a DBR laser. At any time, a DBR laser's temperature profile and its wavelength depends upon the history of its operation, e.g., the heat load and the heat dissipation integrated up to that time. If not compensated, this thermally-induced patterning effect, which is a function of the thermal history of the laser, can cause the laser wavelength to mode hop around the DBR grating wavelength in the manner illustrated in FIG. 2B, causing noise in the output power of the generated higher harmonic light wave. For display applications, noise created by mode hopping could generate lines of varying brightness and some artifacts in the images. Similarly, the thermally-induced patterning effect due to long current pulses injected into the gain section could cause the DBR laser wavelength to completely drift away from its preferred value or from the bandwidth of an associated SHG wavelength conversion device in the manner illustrated in FIG. 2B, where the drift starts at about 1 ms. For example, in display applications, noise created by laser wavelength drift could result in missing image lines.

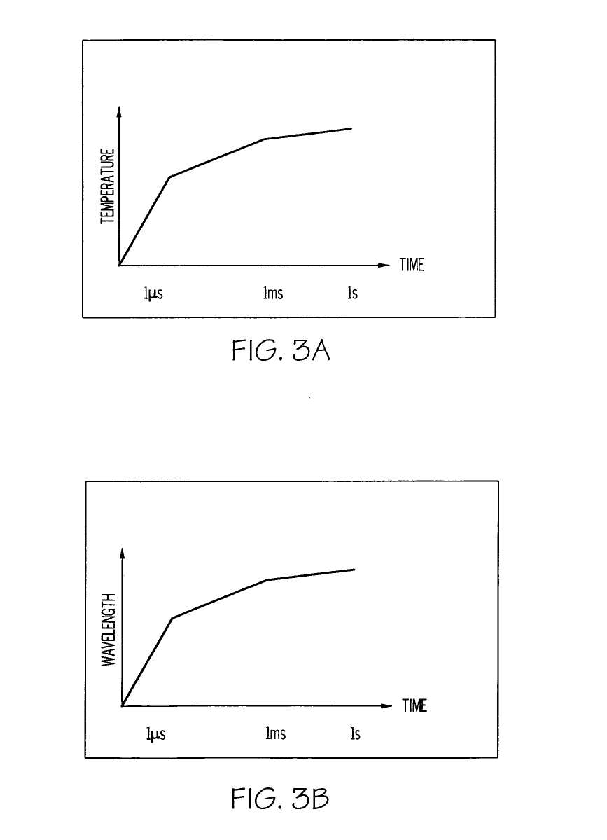

FIGS. 3A and 3B illustrate graphically the behavior of a conventionally-driven DFB semiconductor laser without the benefit of thermal compensation according to the present invention. Current injection into a DFB semiconductor laser increases the temperature of the active region and the cladding region of the laser over time in the manner illustrated in FIG. 3A. This increase in temperature over time leads to an increase in the refractive index of the DFB laser, resulting in an increase in both the optical path length and the Bragg grating wavelength of the laser. As a result, the lasing optical spectrum continuously moves toward longer wavelengths in the manner illustrated in FIG. 3B. As is noted above in the context of DBR semiconductor lasers, the thermally-induced wavelength change also leads to an undesirable patterning effect for DFB lasers. At any time, the temperature profile and the lasing wavelength of a DFB laser will depend upon the history of the laser's operation, i.e., the heat load and the heat dissipation integrated up to that time. If not compensated, this thermally-induced patterning effect can cause the laser wavelength to drift away from its preferred value or from the bandwidth of an associated SHG wavelength conversion device.

The present invention relates to a variety of control schemes that compensate for thermally induced patterning effects in semiconductor lasers as the gain region injection current is modulated. As a result, this present invention provides a high-speed modulation method, without the use of an external modulator, for short wavelength laser devices such as a green laser operating, for example, in the range of between about 490 nm and about 565 nm. Modulation schemes according to the present invention, allow for precise wavelength matching between the semiconductor laser and the associated wavelength conversion device, e.g., the SHG crystal. In this way, the output light of the semiconductor laser is fully utilized and an efficient short wavelength laser source can be obtained because the modulation methods described herein provide relatively low power consumption and do not degrade laser output power or line width as much as other wavelength modulation schemes.

According to one control scheme of the present invention, the current supplied to one or more micro-heaters integrated in the semiconductor laser is controlled so that the temperature of the laser is maintained at a relatively constant level. Specifically, Referring now to FIGS. 4-6, although the present invention is not limited to the use of particular micro-heating element structures, specific reference is made herein to suitable micro-heating element structures that may be used to control the temperature of a semiconductor laser 10, or selected portions thereof, in the manner described herein. The semiconductor laser 10 may comprise a semiconductor substrate 20 including an active region 30, a ridge waveguide 40, a driving electrode structure, and a micro-heating element structure. In the illustrated embodiment, the driving electrode structure comprises a driving electrode element 50 and the micro-heating element structure comprises a pair of heating element strips 62, 64. The active region 30 is defined by P and N type semiconductor material within the semiconductor substrate 20 and is configured for stimulated emission of photons under an electrical bias V_{BIAS} generated by the driving electrode element 50 and a corresponding N-Type region 25 defined in the substrate 20. The wavelength output of the semiconductor laser 10 is dependent upon the temperature of the ridge waveguide 40 and the active region 30 and the micro-heating element structure is configured to alter the temperature of the ridge waveguide 40 and the active region 30 to tune the wavelength output.

The ridge waveguide 40, which may comprise a raised or buried ridge structure, is positioned to optically guide the stimulated emission of photons along a longitudinal dimension Z of the semiconductor laser 10. For the purposes of defining and describing the present invention, it is noted that the specific structure of the various types of semiconductor lasers in which the concepts of the present invention can be incorporated is taught in readily available technical literature relating to the design and fabrication of semiconductor lasers. For example, and not by way of limitation, the semiconductor laser 10 may comprise a laser diode defining a distributed feedback (DFB) configuration or a distributed Bragg reflector (DBR) configuration.

The heating element strips 62, 64 of the micro-heating element structure extend along the longitudinal dimension Z of the semiconductor laser 10 are fabricated from a material designed to generate heat with the flow of electrical current along a path extending generally parallel to the longitudinal dimension of the ridge waveguide, i.e., along the length of the strips 62, 64. For example, and not by way of limitation, it is contemplated that Pt, Ti, Cr, Au, W, Ag, and Al, taken individually or in various combinations, will be suitable for formation of the strips 62, 64. For example, it may be preferable to utilize an alloy comprising Au and Pt to form the heating element strips 62, 64.

As is illustrated in FIG. 4, the heating element strips 62, 64 are laterally positioned on opposite sides of the ridge waveguide 40 such that one of the heating element strips 62 extends along one side of the ridge waveguide 40 while the other heating element strip 64 extends along the other side of the ridge waveguide 40. Further, the driving electrode element 50 may also extend laterally on opposite sides of the ridge waveguide 40. The driving current to the heating element strips 62, 64 can be controlled to change the heat generated thereby and thus tune or lock the wavelength of the semiconductor laser.

As is further illustrated in FIG. 4, where lateral portions 52, 54 of the driving electrode element 50 extend laterally on opposite sides of the ridge waveguide 40, the driving electrode structure and the micro-heating element structure may preferably be arranged such that the lateral portion 52 of the driving electrode element 50 and the corresponding heating element strip 62 extend along the same side of the ridge waveguide 40, occupying respective portions of a common fabrication layer on the same side of the ridge waveguide 40. Similarly, the lateral portion 54 of the driving electrode element 50 and the corresponding heating element strip 64 extend along the other side of the ridge waveguide 40, occupying respective portions of a common fabrication layer on the other side of the ridge waveguide 40. As used herein a “common fabrication layer” is a layer of a semiconductor device that comprises one ore more components positioned such that they may be fabricated in a common fabrication step. The identification of components herein as being in a common fabrication layer should not be interpreted to require that they be fabricated in a common plane. For example, referring to FIG. 4, the driving electrode element 50 and the heating element strips 62, 64 are not entirely coplanar but may be formed in a common fabrication step. Accordingly, they may be said to lie in a common fabrication layer. In contrast, the driving electrodes element 50 and the active region 30 cannot be said to lie in a common fabrication layer because the nature of the materials forming these components and the location of the components do not lend themselves to fabrication in a common step.

The present inventors have recognized that semiconductor laser tuning and stabilization can be achieved by utilizing thin-film micro-heater designs of the type illustrated in FIG. 4, where heating element strips 62, 64 are provided on both sides of the ridge waveguide 40 and are integrated with the driving electrode structure. Specifically, according to the design of the present invention, the location of the heating element strips 62, 64 can be optimized by allowing for the integration of the heating element strips 62, 64 with the driving electrode structure in a common fabrication layer, on a common side of the ridge waveguide 40. Although the present invention is illustrated in FIGS. 4 and 5 with driving electrode element 50 and corresponding heating element strips 62, 64 extending along both sides of the ridge waveguide 40, it is contemplated that driving electrode element 50 need not include the lateral portions 52, 54 or be provided on both sides of the ridge waveguide 40.

Also illustrated in FIG. 4 are respective direct heating paths 22, 24 that extend from the heating element strips 62, 64 of the micro-heating element structure, through the semiconductor substrate 20, to the active region 30. According to the illustrated embodiment of the present invention, the heating element strips 62, 64 are positioned such that the driving electrode structure does not interfere substantially with the direct heating paths 22, 24. “Substantial” interference with the direct heating paths can be quantified by referring to the amount of heat “sinked” by portions of the driving electrode structure interfering with the direct heating paths 22, 24. For example, it is contemplated that any interference that would reduce the amount of heat reaching the active region 30 by greater than about 10% to about 25% would be “substantial” interference with the direct heating path. In some contemplated preferred embodiments, the degree of interference corresponds to a reduction in directed heat of less than about 5%. In further contemplated embodiments, the heating element strips 62, 64 are positioned such that the driving electrode structure completely avoids interference with the direct heating paths 22, 24. In all of these embodiments, any heat sinking effect attributable to the driving electrode structure can be minimized, or at least reduced to a significant extent.

The micro-heating element structure should be positioned close enough to the active region 30 to ensure that heat generated by the heating element strips 62, 64 reaches the active region 30 area quickly, e.g., in about 4 microseconds or less. For example, and not by way of limitation, the heating element strips 62, 64 of the micro-heating element structure could be positioned such that they are displaced from the PN junction of the active region 30 by less than about 5 μm. It is contemplated that the spacing between the heating element strips 62, 64 and the active region 30 could be significantly less than 5 μm, e.g., about 2 μm, if the fabrication processes for forming the strips 62, 64 and the driving electrode structure are sufficiently precise.

Care should be taken to ensure that the operation of the driving electrode structure is not inhibited by the electrically conductive elements of the micro-heating element structure. For example, to this end, it may be preferable to ensure that the heating element strips 62, 64 of the micro-heating element structure are displaced from the driving electrode element 50 by at least about 2 μm. As is illustrated in FIG. 4, the resistive thin film forming the heating element strips 62, 64 and the various electrically conductive layers forming the driving electrode structure and the micro-heating element structure may be formed on an electrically insulating thin film 70 deposited directly on the semiconductor substrate 20. It is additionally noted that a thin protective coating may be formed over heating element strips 62, 64.

Referring to FIG. 5, the driving electrode structure may preferably comprise anode electrode regions 56 and the P-type metal of the driving electrode element 50 formed over and around the ridge waveguide 40 for current injection and heat distribution. The anode metal is connected to the P-type metal of the driving electrode element 50 through electrically conductive traces 55 formed around the heating element strips 62, 64 and the heating element contact pads 66. The heating element strips 62, 64 are located on both sides of the ridge 40, several micrometers to tens of micrometers away from the PN junction of the active region 30. There is a gap of several micrometers between the heating element strips 62, 64 and the P-type metal for electrical insulation. There is also a gap between the heating element strips 62, 64 and the anode electrode regions 56 and heating element contact pads 66. This gap width may be tailored so that the heat generated by the heating element strips 62, 64 would not be substantially dissipated through the anode electrode regions 56. As is noted above, it is contemplated that the aforementioned gap width may preferably be at least ten micrometers. It is contemplated that “substantial” dissipation of the heat generated by the heating element strips can be quantified by referring to the amount of heat “sinked” by portions of the anode electrode regions 56 and heating element contact pads 66. For example, it is contemplated that any dissipation by these elements that would reduce the amount of heat reaching the active region 30 by greater than about 10% to about 25% would be “substantial.” In some contemplated preferred embodiments, the degree of dissipation corresponds to a reduction in directed heat of less than about 5%.

According to one embodiment of the present invention, the heating element strips 62A, 64A, 62B, 64B are configured to extend along the longitudinal dimension of the ridge waveguide 40 in the wavelength selective region 12 and the phase matching region 14 but do not extend a substantial distance in the gain region 16. This type of configuration has operational advantages in contexts where thermal control of the wavelength selective region 12 and the phase matching region 14 is desired.

The present invention contemplates thermal tuning by varying the temperatures of the wavelength selective region 12 or the phase matching region 14. The present invention also contemplates thermal tuning by varying the temperatures of the wavelength selective region 12 and the phase matching region 14—a feature of the present invention that enables continuous wavelength tuning without mode hops. Additionally, the present invention contemplates that the integrated micro-heaters described herein can be fabricated on any of the regions 12, 14, 16 for additional functionalities, such as removing mode hopping by phase thermal compensation and/or gain thermal compensation, achieving wavelength stability during gain current modulation. Accordingly, the present invention contemplates that temperature control of the gain region 16 may be preferred in some circumstances, either alone or in combination with temperature control in the wavelength selective region 12 and the phase matching region 14. In cases where temperature control in multiple regions is preferred, the heating element strips and the associated micro-heating element structure are configured to enable independent control of heating in each region.

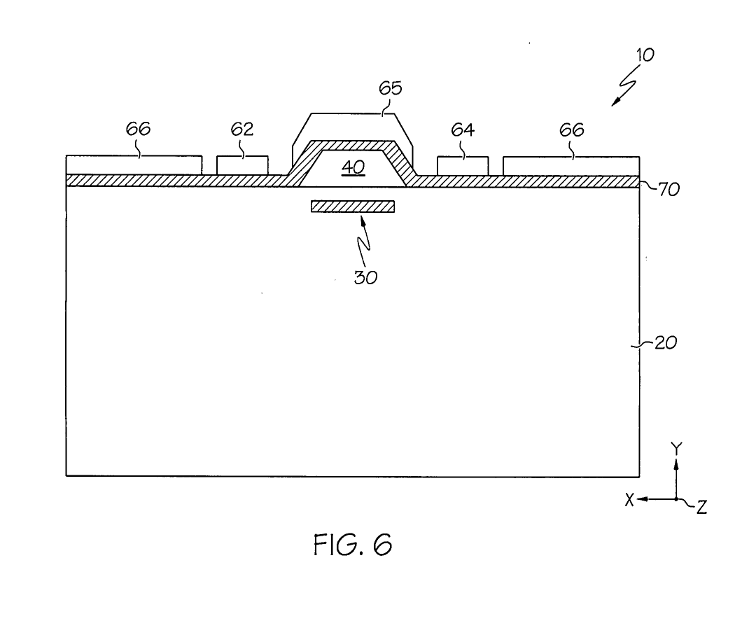

Referring to FIG. 6, according to another embodiment of the present invention, the micro-heating element structure comprises a heating element strip 65 that extends along the longitudinal dimension Z of the semiconductor laser 10 over the ridge waveguide 40. In the context of a DBR-type laser, a heating element strip 65 of the type illustrated in FIG. 6 can be used to effectively heat either the wavelength selective region 12 or the phase matching region 14 of a DBR-type laser (see FIG. 1B) because these regions can be fabricated to exclude electrically conductive elements of the driving electrode structure. As is illustrated in FIG. 6, driving electrode elements 52, 54 may be provided alongside the ridge waveguide 40 where their inclusion is necessary or preferred.

As is illustrated in FIG. 6, the intervening space extending along the longitudinal dimension Z of the semiconductor laser 10 between the heating element strip 65 and the ridge waveguide 40 does not include any electrically conductive elements from the driving electrode structure. As a result, a direct heating path unencumbered by electrically conductive elements that could sink heat from the system can be established between the active region 30 and the heating element strip 65. It is contemplated that the width of the heating element strip 65 may preferably be at least as large as the width of the active region 30 but less than about four times the width of the active region 30.

Although the above-described micro-heating element structure may represent the preferred means for controlling the temperature of the laser according to the present invention, it is noted that the temperature control schemes of the present invention are not necessarily limited to use of such structure. For example, according to one embodiment of the present invention, a method of compensating for thermally induced patterning effects in a semiconductor laser is provided where, for at least a portion of a duration over which said heating element is driven by said heating element driving current I_{H}, the laser's heating element driving current I_{H} is set to a relatively high magnitude when the laser's driving current I_{D} is at a relatively low magnitude. Further, the laser's heating element driving current I_{H} can, for at least a portion of the heating period, be set to a relatively low magnitude when the laser's driving current I_{D} is at a relatively high magnitude. Reference is made herein on a number of occasions to electrical currents of relatively high and relatively low magnitudes without specific identification of actual current magnitudes because the actual current magnitudes selected for driving the heating elements and the active region of a particular laser will depend on the construction of the laser and the design of the heating elements. For the purposes of describing and defining the present invention, it is noted that heating element driving currents I_{H} are described herein as relatively high and relatively low in relation to each other, and not in relation to other current values, such as the laser driving current I_{D}. Similarly, laser driving currents I_{D} are described herein as relatively high and relatively low in relation to each other, and not in relation to other current values, such as the heating element driving currents I_{H}.

Reference is made throughout the present application to various types of currents. For the purposes of describing and defining the present invention, it is noted that such currents refer to electrical currents. Further, for the purposes of defining and describing the present invention, it is noted that reference herein to “control” of an electrical current does not necessarily imply that the current is actively controlled or controlled as a function of any reference value. Rather, it is contemplated that an electrical current could be controlled by merely establishing the magnitude of the current.

More specifically, for DFB-type semiconductor lasers of the type illustrated in FIG. 1A, the overall temperature variation in the laser consists of the temperature variation caused by the laser's driving current I_{D} and the temperature variation caused by the heating element driving current I_{H}. The heating element driving current I_{H} can be controlled, i.e., reduced or raised, to reduce the thermally-induced patterning effect arising from historical thermal conditions in the semiconductor laser by reducing the overall variation of the junction temperature T_{J} of the active region. As a result, the wavelength of the modulated laser output signal P_{λ} can be maintained at a preferred value, e.g., at a value that matches the optimum wavelength of the wavelength conversion device to which it may be coupled. Because the grating covers the entire length of the active region of a DFB-type laser, the optical path length and the grating wavelength are each a function of the diffractive index of a common optical path. Accordingly, the optical path length and the grating wavelength can both be stabilized by keeping the temperature of the grating region constant.

From a thermodynamic point of view, it may take a significant amount of time for the heat generated by the micro-heater to be diffused to the active area of the laser because the micro-heater is displaced from the active area by, e.g., a few micrometers. On the other hand, the current injection heats up the laser active region directly. Thus, according to a further embodiment of the present invention, the heating element driving current I_{H} is controlled to decrease before the laser driving current I_{D} starts to increase. Further, although not required, it is contemplated that the heating element driving current I_{H} can be controlled to increase before the laser driving current I_{D} starts to decrease.

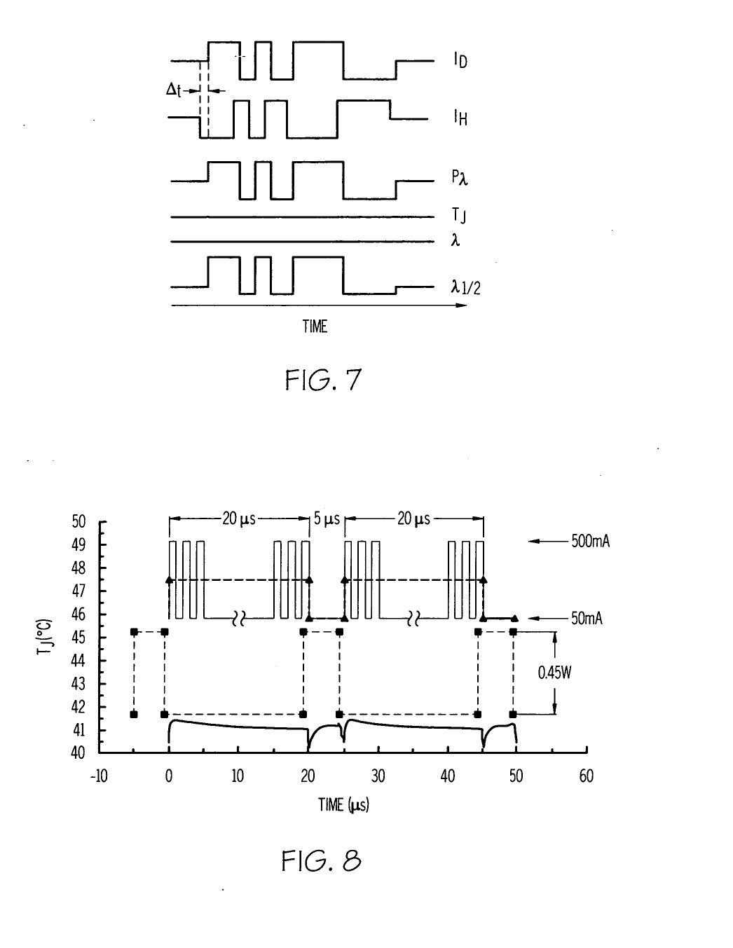

FIG. 7 is a timing diagram illustrating a method of compensating for thermally induced patterning effects in a semiconductor laser where the phase of the modulated laser driving current I_{D} is delayed relative to the phase angle of the heating element driving current I_{H} by a time delay Δt. In FIG. 7, elapsed time is plotted along the x-axis while the increasing and decreasing magnitudes of respective waveforms for the laser driving current I_{D}, the heating element driving current I_{H}, the modulated laser output signal P_{λ}, the junction temperature T_{J}, lasing wavelength λ, and the SHG output power λ_{1/2} are plotted along the y-axis.

As is illustrated in FIG. 7 in the context of a DFB laser coupled to an SHG wavelength conversion device, wavelength matching of the DFB laser and the SHG crystal is achieved initially under a continuous wave condition. Then transition is made to a modulation mode. The heating element driving current I_{H} is turned to a relatively low magnitude before the laser driving current I_{D} is turned to a relatively high magnitude. It is contemplated that the time delay Δt could range from sub-microseconds to several microseconds, depending on the integrated micro-heater configuration. Similarly, the heating element driving current I_{H} can be changed to a relatively high magnitude before the laser driving current I_{D} is changed to a relatively low magnitude.

In this manner, the heating element driving current I_{H}, which is illustrated as the 0.45 Watt amplitude square wave in FIG. 8, can be controlled to maintain the junction temperature T_{J} at a substantially constant value. For example, according to the embodiment of the present invention illustrated in FIG. 8, where the junction temperature T_{J} is represented as the lower solid line, the junction temperature T_{J} is maintained between about 40.5° C. and about 41.5° C. In practicing the present invention, it is contemplated that substantially constant junction temperatures will fall within a temperature variation band of about ±2° C. or, more preferably, about ±0.5° C. Junction temperature profiles including temperature spikes or other temperature variations outside of the aforementioned band may also be considered substantially constant if the variations account for a relatively brief portion of the temperature profile, e.g., on the order of a few microseconds for a temperature profile sample having a duration on the order of tens of microseconds. In FIG. 8, the time delay Δt, which is equivalent to the phase angle between the phase of the heating element driving current I_{H} and the laser driving current I_{D}, is evident.

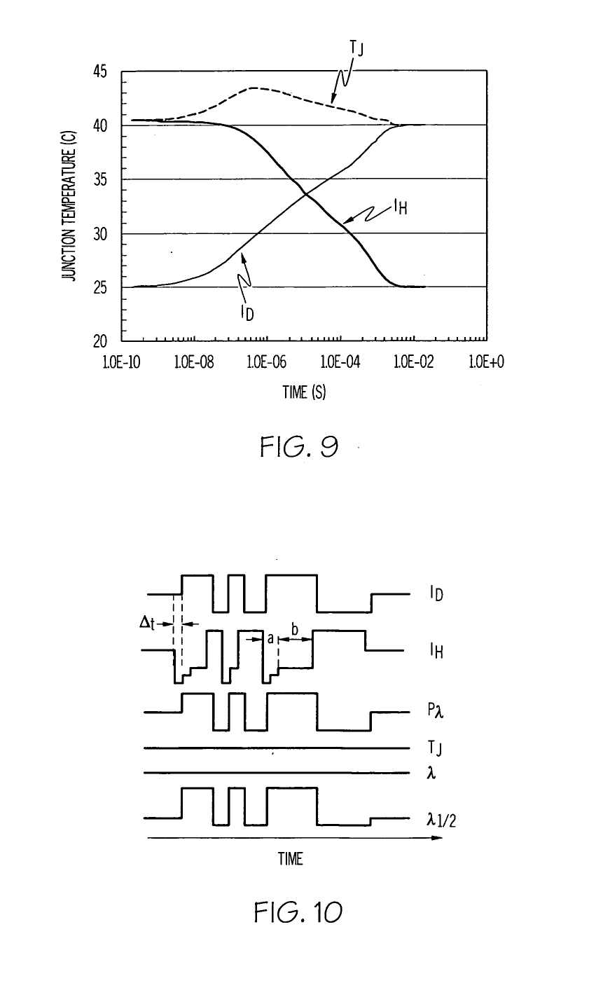

A further refinement of the compensation scheme of the present invention can be illustrated with reference to FIG. 9, where a calculated junction temperature T_{J} is plotted as a function of time after the heating element driving current is decreased and the laser driving current is increased. FIG. 9 also presents the respective components of the calculated junction temperature T_{J} arising from the decrease in the heating element driving current and the increase in the laser driving current. These respective component temperature plots are labeled as I_{D} and I_{H} in FIG. 9 to clarify their respective relation to the laser driving current I_{D} and the heating element driving current I_{H}. During modulation, when the laser driving current I_{D} is turned from low to high and the heating element driving current I_{H} is turned from high to low, the junction temperature T_{J} exhibits an overshoot from its target value at the beginning of the on state and then gradually tapers down stabilizes. This overshoot arises because the junction temperature T_{J} changes faster in response to changes in the laser driving current I_{D} than it does in response to changes in the heating element driving current I_{H}.

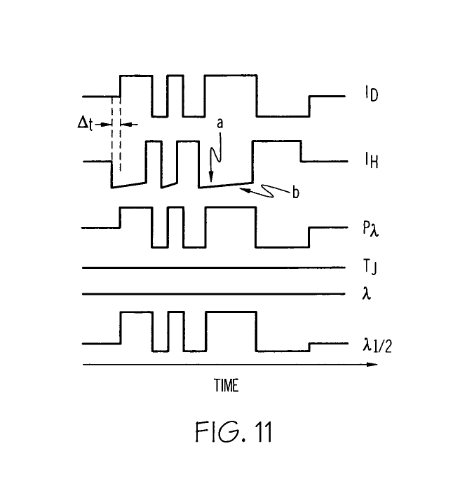

The present invention partially compensates for the aforementioned overshoot by incorporating the time delay Δt in the laser driving current I_{D} and heating element driving current I_{H} signals. According to an additional embodiment of the present invention, further compensation of the junction temperature T_{J} overshoot can be achieved by controlling the magnitude of the heating element driving current I_{H} so that the sum of the temperature rise caused by heating attributable to the laser driving current I_{D} and heating attributable to the heating element driving current I_{H} is maintained substantially constant. Referring to FIGS. 10 and 11, for example, the heating element driving current I_{H} is not only turned down in advance, but is also changed to a lower current value than would be the case if the heating element driving current I_{H} were held at the relatively constant low value. In contrast, in the embodiment of the present invention illustrated in FIGS. 7 and 8, the heating element driving current I_{H} transitions in time from a substantially constant relatively low magnitude to a substantially constant relatively high magnitude.

According to the embodiment of the present invention illustrated in FIGS. 10 and 11, the heating element driving current I_{H} is controlled such that its relatively low magnitude portion comprises a minimum current value portion a and a maximum current value portion b. The heating element driving current I_{H} can transition from the minimum current value portion a to the maximum current value portion b along a temperature profile that increases in stepped increments, as is illustrated in FIG. 10, or gradually, as is illustrated in FIG. 11. In either case, the heating element driving current I_{H} transitions from a relatively high heating element driving current I_{H} to the minimum current value portion a, from the minimum current value portion a to the maximum current value portion b, and from the maximum current value portion b to a relatively high heating element driving current I_{H}.

It is contemplated that a high pass frequency filter or similar hardware can be used to achieve the above-described variation of the heating element driving current I_{H} and the noted time delay Δt in the laser driving current I_{D} and heating element driving current I_{H} signals. According to this aspect of the present invention, the amplitude and phase angle of the heating element driving current I_{H} are added with a high-pass filter response to best compensate for the change of optical path length caused by the laser driving current. The filter response in the frequency domain is approximately the difference between the frequency-dependent temperature responses due to the laser driving current I_{D} and the heating element driving current I_{H} The characteristics of the frequency filter can be obtained by numerical simulation or experimental measurement of the frequency-dependent temperature responses due to the laser driving current I_{D} and the heating element driving current I_{H} It is further contemplated that the filtering function illustrated in FIGS. 10 and 11 may merely be needed when the heating element driving current I_{H} transitions from a high level to a low level because when the heater current transitions from a low level to high level, the laser driving current I_{D} transitions to a low level that is near or below the laser threshold. When the laser driving current I_{D} transitions to this low level, the laser output signal P_{λ} is off and thermal compensation does not need to be addressed in some applications. In general, the response time of the micro-heating element structure is slower than that of the laser driving current I_{D} so the filter function will often need to be employed whenever the laser is activated or modulated between active states of different output powers. For example, compensation may be needed where the laser driving current I_{D} transitions to a low level that corresponds to a reduced but non-zero laser output signal P_{λ}.

In the context of the DBR-type laser illustrated with reference to FIG. 1B and described in detail above, the present invention is also directed to thermal compensation schemes where the phase matching region 14 of the semiconductor laser 10 is heated with a micro-heating element structure that extends over the phase matching region 14. In this embodiment, the micro-heating element structure can fabricated on the phase matching region 14 in any of the configurations described herein or in any conventional or yet to be developed configuration. During modulation, the laser output signal P_{λ}, is increased or decreased by increasing or decreasing the laser driving current I_{D} in the gain region 16. As described above, the heat generated by the laser driving current I_{D} changes the optical path length of the gain region 16 and the laser is susceptible to mode hopping. To compensate for this susceptibility, the heating element driving current I_{H}, and consequently the heat generated in the phase matching region 14, is controlled so that the total optical cavity length of the DBR laser remains substantially constant. This approach not only addresses mode hopping, but also helps reduce Bragg wavelength drift in the laser because the sum of the temperature rise caused by heating attributable to the laser driving current I_{D} and heating attributable to the heating element driving current I_{H} is maintained substantially constant.

It is also contemplated that the phase matching region 14 can be further heated by injecting electrical current I_{J} into the phase matching region 14. The heating element driving current I_{H} and the injection current I_{J} can be controlled such that optical path length compensation in the phase matching region 14 is initially achieved under the primary influence of the injection current I_{J} and is subsequently achieved under the primary influence of the heating element driving current I_{H}. In this manner, the heating element driving current I_{H} and the injection current I_{J} can be used together to compensate for any change of optical path length caused by the laser driving current I_{D} in the gain region 16. The injection current I_{J} is able to heat the phase matching region 14 more quickly than the heating element driving current I_{H}. Conversely, the heating element driving current I_{H} and the micro-heating element structure are often less prone than the injection current I_{J} to introduce undesirable effects in the laser, such as increase of optical loss and increase of line width. In addition, I_{H} is often more efficient in term of laser temperature change per unit power of electrical input than I_{J} under a continuous wave (CW) condition. Accordingly, the present invention contemplates combining the use of phase region injection current and phase region heating element driving current I_{H} in the manner described above to compensate for changes of optical path length caused by the laser driving current I_{D} in the gain region 16.

Referring further to the context of the DBR-type laser illustrated in FIG. 1B, the present invention is also directed to thermal compensation schemes where the gain region 16 of the semiconductor laser 10 is heated with a micro-heating element structure that extends over the gain region 16, as opposed to the phase region 14. In this manner, the integrated micro-heating element structure fabricated on the gain section can be used to directly cancel-out any change in optical path length caused by the gain injection current.

A number of advantages will be readily apparent to those practicing the present invention. For example, in many cases it may not be necessary to vary the driving current to maintain constant thermal loading or to use an external optical intensity modulator for feedback control of a directly modulated laser. In the context of a DBR-type laser, in many cases it may not be necessary to control current injection in the gain, phase, or wavelength selective regions of the laser to bring the laser wavelength back to the spectral center of the wavelength conversion device. Further, in some circumstances it may not be necessary to use optical feedback from the optical output of the wavelength conversion device to which the laser is coupled to adjust the DBR-section current or the phase-section current of the laser.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents. For example, although the present description illustrates the concepts of the present invention in the context of a raised ridge waveguide, it is contemplated that the present invention will also have utility in the context of a “buried” ridge waveguide structure. Accordingly, the recitation of a “ridge waveguide” in the appended claims includes raised and buried ridge waveguides and should not be taken as limited to raised ridge waveguide structures.

It is noted that terms like “preferably,” “commonly,” and “typically,” when utilized herein, are not intended to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

What is claimed is:

1. A method of compensating for thermally induced patterning effects in a semiconductor laser, said method comprising:
driving an active region of said semiconductor laser with a laser driving current I_{D} sufficient to generate stimulated emission of photons in said active region;
generating a modulated laser output signal P_{λ} by driving said active region of said semiconductor laser with relatively high magnitude and relatively low magnitude laser driving currents I_{D};
heating said active region of semiconductor laser with a heating element driving current I_{H} to generate heat in a heating element structure thermally coupled to said active region; and
controlling a junction temperature T_{J} of said active region by driving said heating element with relatively high magnitude and relatively low magnitude heating element driving currents I_{H}, wherein said control of said laser driving current I_{D} and said control of said heating element driving current I_{H} are such that
said heating element driving current I_{H} is at said relatively high magnitude when said laser driving current I_{D} is at a relatively low magnitude for at least a portion of a duration over which said heating element is driven by said heating element driving current I_{H}, and
said heating element driving current I_{H} decreases from said relatively high magnitude to said relatively low magnitude at a time prior to an increase in said laser driving current I_{D} from said relatively low magnitude to said relatively high magnitude.

2. A method as claimed in claim 1 wherein said heating element driving current I_{H} is controlled relative to said laser driving current I_{D} to compensate at least partially for thermally-induced patterning effects arising from historical thermal conditions in the semiconductor laser.

3. A method as claimed in claim 1 wherein:
said heating element driving current I_{H} is controlled such that said relatively low magnitude comprises a minimum current value portion a and a maximum current value portion b; and
said heating element driving current I_{H} transitions in time from said minimum current value portion a to said maximum current value portion b along a temperature profile that increases gradually or in stepped increments.

4. A method as claimed in claim 3 wherein said heating element driving current I_{H} transitions in time from:
said relatively high heating element driving current I_{H} to said minimum current value portion a of said relatively low heating element driving current I_{H};
said minimum current value portion a to said maximum current value portion b of said relatively low heating element driving current I_{H}; and
said maximum current value portion b of said relatively low heating element driving current I_{H} to said relatively high heating element driving current I_{H}.

5. A method as claimed in claim 1 wherein said heating element driving current I_{H} is controlled so as to maintain said junction temperature T_{J} at a substantially constant value.

6. A method as claimed in claim 1 wherein said heating element driving current is controlled to compensate for said thermally-induced patterning effects by initiating a reduction in said heating element driving current I_{H} prior to an increase in said laser driving current I_{D}.

7. A method as claimed in claim 1 wherein said compensation for said thermally-induced patterning effects is limited to conditions where said laser driving current transitions from an off state to an on state or between two on states of different power levels.

8. A method as claimed in claim 1 wherein said control of said laser driving current I_{D} and said control of said heating element driving current I_{H} are such that:
said heating element driving current I_{H} is at said relatively low magnitude when said laser driving current I_{D} is at a relatively high magnitude for at least a portion of a duration over which said heating element is driven by said heating element driving current I_{H}; and
said heating element driving current I_{H} increases from said relatively low magnitude to said relatively high magnitude at a time prior to a decrease in said laser driving current I_{D} from said relatively high magnitude to said relatively low magnitude.

9. A method as claimed in claim 1 wherein the phase of said modulated laser driving current I_{D} is delayed relative to the phase of said heating element driving current I_{H} by a time delay Δt.

10. A method as claimed in claim 1 wherein:
said semiconductor comprises a DFB laser diode comprising a distributed feedback grating; and
said active region of semiconductor laser is heated with a micro-heating element structure extending over a substantial portion of said distributed feedback grating.

11. A method as claimed in claim 1 wherein:
said semiconductor comprises a DBR laser diode comprising a wavelength selective region, a phase matching region, and a gain region; and
said semiconductor laser is heated with a micro-heating element structure extending over said gain region.

12. A method as claimed in claim 1 wherein:
said semiconductor comprises a DBR laser diode comprising a wavelength selective region, a phase matching region, and a gain region; and
said semiconductor laser is heated with a micro-heating element structure extending over said phase matching region.

13. A method of compensating for thermally induced patterning effects in a DBR laser diode comprising a wavelength selective region, a phase matching region, and a gain region, said method comprising:
driving an active region of said semiconductor laser with a laser driving current I_{D} sufficient to generate stimulated emission of photons in said active region;
generating a modulated laser output signal P_{λ} by driving said active region of said semiconductor laser with relatively high magnitude and relatively low magnitude laser driving currents I_{D};
heating said phase matching region of said DBR laser by applying a heating element driving current I_{H} to a micro-heating element structure extending over at least a portion of said phase matching region to generate heat in said micro-heating element structure; and
controlling said laser driving current I_{D} and said heating element driving current I_{H} such that, for at least a portion of a duration over which said heating element is driven by said heating element driving current I_{H}, said heating element driving current I_{H} is at a relatively high magnitude when said laser driving current I_{D} is at said relatively low magnitude and said heating element driving current I_{H} is at a relatively low magnitude when said laser driving current I_{D} is at said relatively high magnitude to compensate at least partially for an increase in optical path length attributable to heat generated in said active region by said laser driving current I_{D}.

14. A method as claimed in claim 13 wherein said phase matching region is further heated by injecting electrical current I_{J} into said phase matching region.

15. A method as claimed in claim 14 wherein said heating element driving current I_{H} and said injection current I_{J} are controlled such that said optical path length compensation is initially achieved under the primary influence of the injection current I_{J} and is subsequently achieved under the primary influence of the heating element driving current I_{H}.

16. A method as claimed in claim 13 wherein said heating element driving current I_{H} in said phase matching region and said laser driving current I_{D} in said active region are controlled such that the total optical path length of said DBR laser is maintained at a substantially constant value.

17. A method as claimed in claim 13 wherein said heating element driving current I_{H} decreases from said relatively high magnitude to said relatively low magnitude at a time prior to an increase in said laser driving current I_{D} from said relatively low magnitude to said relatively high magnitude.

18. A method as claimed in claim 13 wherein said heating element driving current I_{H} transitions in time from a substantially constant relatively low magnitude to a substantially constant relatively high magnitude.

19. A method as claimed in claim 13 wherein:
said heating element driving current I_{H} is controlled such that said relatively low magnitude comprises a minimum current value portion a and a maximum current value portion b; and
said heating element driving current I_{H} transitions in time from said minimum current value portion a to said maximum current value portion b along a temperature profile that increases gradually or in stepped increments.

20. A method of compensating for thermally induced patterning effects in a semiconductor laser comprising a semiconductor substrate, an active region, a ridge waveguide, a driving electrode structure, and a micro-heating element structure, wherein:
said active region is defined within said semiconductor substrate and is configured for stimulated emission of photons under an electrical bias generated by said driving electrode structure;
said ridge waveguide is positioned to optically guide said stimulated emission of photons along a longitudinal dimension of said semiconductor laser;
said micro-heating element structure comprises a pair of heating element strips extending along said longitudinal dimension of said semiconductor laser;
said heating element strips are on opposite sides of said ridge waveguide such that one of said heating element strips extends along one side of said ridge waveguide while a remaining heating element strip extends along another side of said ridge waveguide; and
said method comprises driving an active region of said semiconductor laser with a laser driving current I_{D} sufficient to generate stimulated emission of photons in said active region, generating a modulated laser output signal P_{λ} by driving said active region of said semiconductor laser with relatively high magnitude and relatively low magnitude laser driving currents I_{D}, heating said active region of semiconductor laser with a heating element driving current I_{H} to generate heat in a heating element structure thermally coupled to said active region, and controlling a junction temperature T_{J} of said active region by driving said heating element with relatively high magnitude and relatively low magnitude heating element driving currents I_{H}, wherein, for at least a portion of a duration over which said heating element is driven by said heating element driving current I_{H}, said heating element driving current I_{H} is at said relatively high magnitude when said laser driving current I_{D} is at said relatively low magnitude and said heating element driving current I_{H} is at said relatively low magnitude when said laser driving current I_{D} is at said relatively high magnitude.
